(19) United States
(12) Patent Application Publication
(10) Pub. No.: US 2009/0181867 A1
(43) Pub. Date: Jul. 16, 2009

(54) CORROSION INHIBITORS FOR OILFIELD APPLICATIONS

(75) Inventors: Jiang Yang, Missouri City, TX (US); Vladimir Jovancicevic, Richmond, TX (US)

Correspondence Address: MADAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/972,301

(22) Filed: Jan. 10, 2008

(51) Int. Cl. C09K 8/68

(52) U.S. Cl. 507/243

(57) ABSTRACT

Imidazoline dimer-type compounds which are prepared by the reaction of dimer fatty acid and a dialkylene triamine, such as diethylenetriamine (DETA), are useful for corrosion inhibition in water-containing fluids contacting metal, particularly fluids containing CO₂ and/or H₂S. When the reaction is conducted with molar excess of the polyamine, the resulting imidazoline dimer or oligomer is surprisingly more effective at corrosion inhibition than conventional monomeric imidazoline. Also unexpected is the better water solubility of the reaction product as compared with the conventional monomeric imidazoline.

### TECHNICAL FIELD

The invention relates to methods and compositions for inhibiting the corrosion of metals, and, in one non-limiting aspect, more particularly relates to methods and compositions for inhibiting corrosion of metals in acid environments where the metal is in contact with a fluid containing water and compounds such as carbon dioxide (CO₂), hydrogen sulfide (H₂S), and the like.

### TECHNICAL BACKGROUND

In earlier years of producing subterranean wells, the vast majority of production and workover conduits comprised carbon steels. These steels were utilized either temporarily or permanently in the well, and treatment and/or stimulation fluids were introduced through them into the well. More recently, due primarily to the drilling and completion of many subterranean wells through formations which contain high concentrations of corrosive materials such as hydrogen sulfide (H₂S), carbon dioxide (CO₂), brine, and combinations of these constituents, the production and workover conduits for use in the wells have been made of high alloy steels. The high alloy steels include chrome steels, duplex steels, stainless steels, martensitic alloy steels, ferritic alloy steels, austenitic stainless steels, precipitation-hardened stainless steels, high nickel content steels, and the like.

It is well known that steel surfaces will corrode in the presence of the acid environments described. While the rate at which corrosion will occur depends on a number of factors, such as the steel alloy itself, the strength and type of corrosive components in the environment, the temperature of the environment, the length of contact, etc., some sort of corrosion invariably occurs. Alloy technology has provided materials to withstand the incidental contact of steel with corrosive components such as CO₂ and/or H₂S, but the corrosion problem is particularly aggravated when there is no choice but to contact steel with these components, as in the case of hydrocarbon exploration, recovery and refining—such as the oil and gas industry and in chemical processing and the like, where these components are inevitably present. In instances where the liquid is not required to remain pure and where the contact is inevitable, attention has turned toward providing corrosion inhibitors in the liquid medium itself to prevent corrosion of the steel surfaces that it must come into contact with, yet still deliver the liquid to its ultimate destination. It would be advantageous if a new corrosion inhibitor were discovered that would be an improvement over the presently known systems. For example, a corrosion inhibitor providing a large corrosion inhibiting effect for a small proportion used would be advantageous.

Specific environments in which an improved corrosion inhibitor would be appreciated include industrial cleaning and hydrocarbon recovery operations. With respect to oil and gas production, it is well known that during the production life of an oil or gas well, the production zone, including tubular goods, downhole tools and other equipment within the well may be exposed to corrosive conditions. Because of the acidic nature of the treatment fluid, produced fluids, etc., the production or workover conduit which is utilized in the well in such applications encounters considerable acidic corrosion, in the forms of surface pitting, localized corrosion, embrittlement, loss of metal component and the like.

Various corrosion inhibitors are known, to which are added other components, such as intensifiers, surfactants, oil wetting components, and the like. The corrosion inhibitors are widely used in oil and gas production wells and pipelines to prevent production equipment failures that can have significant impact on safety and environment and loss of production. Certain alkyl imidazolines are known to be used in the oilfield as inhibitors to control CO₂ and H₂S corrosion.

There remains a need for new corrosion inhibitors and methods of use therefore which would work in these corrosive environments for a wide variety of metals, particularly iron alloys such as steels.

### SUMMARY

There is provided, in one non-limiting embodiment, a method of inhibiting the corrosion of a metal in contact with a liquid that includes water. The method involves adding to the liquid an imidazoline reaction product of a dimeric fatty acid and a dialkylene triamine, where the molar ratio of dimeric fatty acid to dialkylene triamine ranges from 1:2 to 1:4, and where the amount of the imidazoline reaction product is effective to inhibit corrosion of the metal.

Additionally, there is provided in another non-restrictive version, a corrosion inhibited liquid that is in contact with a metal. The liquid includes water, and an imidazoline reaction product of a dimeric fatty acid and a dialkylene triamine, where the molar ratio of dimeric fatty acid to dialkylene triamine ranges from 1:2 to 1:4, and where the amount of the imidazoline reaction product is effective to inhibit corrosion of the metal.

### DETAILED DESCRIPTION

It has been unexpectedly found that an imidazoline product formed by reaction of dimer acid and diethylene triamine or other alkylamines present in molar excess compared to the dimer acid, provides better corrosion inhibitor than conventional imidazoline. The reaction product is believed to be a dimer or oligomer imidazoline product, in contrast to conventional monomeric imidazoline.

It will be shown that better corrosion inhibition may be achieved by employing the imidazoline reaction product of dimer acid and diethylenetriamine. This material unexpectedly gave better film persistency and corrosion inhibition over the conventional reaction product of the corresponding mono acid and diethylenetriamine. It was discovered that there is an optimum molecular weight range (between about 400 and about 1200 weight average molecular weight) where the product performs at the highest level. Alternatively, the lower molecular weight threshold may be about 600, where independently the upper molecular weight threshold may optionally be about 1000. Products with higher molecular weights than these ranges are not desirable as they are less effective.

The imidazoline corrosion inhibitors herein may be prepared from a dimer fatty acid with alkyl chain length from C16 to C22. Dimer acid may be obtained from condensation reaction of corresponding monomeric fatty acid, which forms ring linking between the alkyl chains. The term “dimer acid” is generally understood to be a mixture of such acids. Such initial monomeric fatty acids may be obtained from corn oil, linseed oil, olive oil, palm oil, peanut oil, rapeseed oil, tall oil, safflower oil, etc. In one non-limiting embodiment, fatty acids from tall oil are suitable. Dimer acid production may be based on thermal Diels-Alder type condensation of unsaturated fatty acids, in one particular non-limiting version from C18 fatty acid from tall oil. The reaction product may be a mixture of monobasic (C18), tribasic (C54), and the majority of dibasic acid (C36 dimer). Again, the dibasic acid is particularly suitable in some non-limiting embodiments herein.

The imidazoline reaction products herein may be acceptably prepared by the following procedure. A suitable amount of dimer fatty acid and diethylenetriamine is charged into a reaction apparatus. Amide is formed after being heated to 170° C. for 2 hours with the removal of water by product. The further rising of temperature to 230° C. under vacuum will form imidazoline. Unreacted reactants are removed by vacuum distillation. As previously noted, there should be a molar excess of amine to dimer acid. In one non-limiting example, the molar ratio of dimer acid to diethylenetriamine should be from about 1:2 to 1:4, and in another nonrestrictive version the lower threshold of the molar ratio is about 1:2.2 while the upper threshold is independently about 1:3.

It has been discovered that the reaction molar ratio of dimer acid to diethylenetriamine of about 1:1 is undesirable, because this will result in formation of higher molecular weight polymer. It has been found that the polymer is less effective for corrosion inhibition than the dimer or oligomers forms described herein.

It may be difficult to predict in advance the amount of the imidazoline reaction product corrosion inhibitor that should be used for any particular environment, since this proportion will depend upon a number of interrelated factors including, but not necessary limited to, the nature of the fluid and the proportion of corrosive species therein, the nature of the metals being protected, the particular corrosion inhibitor reaction product, the temperature and pressure of the fluid, the amount of time the metal is contacted by the fluid, and the like. Most likely, the suitable proportions or dosages will be determined empirically. In one non-limiting embodiment, the amount of the imidazoline reaction product ranges from about 1 ppm to about 500 ppm, based on the liquid. In another non-restrictive version, the lower proportion threshold is about 2 ppm, while the upper proportion threshold is independently about 200 ppm.

Other corrosion inhibitors may be blended together to enhance the performance of the “dimer” imidazoline herein. Suitable other corrosion inhibitors include, but are not necessarily limited to, aliphatic amines such as alkyl quaternary salts; alkyl phosphate esters; thiophosphate esters; fatty acids such as fatty acids, alkyl dimeric acids, maleated fatty acids, etc. and the like. The alkyl chain length of these other corrosion inhibitors may range from 8 to 24 carbons, and in one non-limiting embodiment, unsaturated chains such as oleyl may find particular utility.

In another non-restrictive version, surfactants may be added as dispersants or solubilization aid so that the “dimer” imidazoline reaction product will disperse through the water phase present and may be evenly distributed throughout the fluid more rapidly. The conventional monomeric imidazoline per se is not soluble in water. Surprisingly, the “dimer” or “oligomer” imidazolines described herein per se are relatively more soluble in water than is the conventional imidazoline. Further, the desired properties of the surfactant include, but are not necessarily limited to, facilitating, improving and assisting the corrosion inhibitor in contacting any metal in contact with the fluid being inhibited. Suitable conventional surfactants such as anionic, nonionic, cationic and amphoteric surfactants may be used.

Suitable anionic surfactants include, but are not necessarily limited to, alkyl sulfates, sulfonates, sulfosuccinates, phosphates, alkyl benzene sulfonates, etc. The alkyl chain length may vary from 8 to 24. Suitable nonionic surfactants include, but are not necessarily limited to, alkoxylated alcohols or ethers; alkyl ethoxylates; alkylamido ethoxylates; alkylamine ethoxylate, alkyl glucosides; alkoxylated carboxylic acids; sorbitan derivatives where the alkyl chain length may range from 8 to 24, etc., for example, nonylphenol ethoxylate-3; alkyl ethoxylates-3; oleyl carboxylic diethylamides; and the like, and mixtures thereof. The suitable surfactants and mixtures thereof include cationic surfactants such as, but not necessarily limited to, monoalkyl quaternary amines, such as cocotrimonium chloride; cetyltrimonium chloride; stearyltrimonium chloride; soyatrimonium chloride; behentrimonium chloride; and the like and mixtures thereof. Other cationic surfactants that are useful may include, but are not necessarily limited to, dialkyl quaternary amines such as dicetyidimethyl ammonium chloride, dicocodimethyl ammonium chloride, distearyidimethyl ammonium chloride, and the like and mixtures thereof. Suitable surfactants and mixtures thereof include anionic surfactants such as, but are not necessarily limited to, fatty carboxylates, alkyl sarcosinates, alkyl phosphates, alkyl sulfonate, alkyl sulfates and the like and mixtures thereof. The amphoteric/zwitterionic surfactants that would be useful include, but are not necessarily limited to, alkyl betaines, alkylamido propyl betaines, alkylampho acetates, alkylamphopropionates, alkylamidopropyl hydroxysultanes and the like and mixtures thereof.

Suitable co-solvents may include fatty alcohols, and alkyl glycol ethers with chain lengths from 3 to 8, branched or straight chain. A particularly useful chain length is 4 to 6. Useful solvents include, but are not necessarily limited to, isopropanol, butanol, pentanol, hexanol, butyl monoglycol ether, butyl diglycol ether, etc. and mixtures thereof.

The corrosion inhibitor described herein may be solubilized in an oil phase or as water soluble salt. The imidazoline “dimer/oligomer” corrosion inhibitor may also be used as a batch treatment or in continuous injection. The corrosion inhibitor herein aids corrosion control at elevated temperatures and pressures.

It will be appreciated that the halogen acid corrosion inhibitor herein may be used with conventional corrosion inhibitors as described above, and in any application where a steel surface, such as stainless steel, high alloy or other steel, is exposed to an acidic or acid environment. While the specific implementation of the methods and compositions herein is described in the context of the oil patch, they may certainly find uses in other applications where it is desirable to reduce corrosion, such as chemical processes that necessarily require the contact of acidic species and acids with conduits, fittings, and other equipment, such as used in industrial cleaning applications.

In the implementation of the methods and corrosion inhibitors herein in the production of fluids from subterranean reservoirs, a fluid may be introduced through a high alloy steel member or conduit positioned within the well. The corrosion inhibitor herein is introduced, added, or injected into the fluid. As noted, the fluid may contain an acidic species such as CO₂ and/or H₂S. The methods herein also encompass a method of treating a well for enhancement of production within a production zone by introduction or addition into a fluid, particularly one containing an acid, and the corrosion inhibitor composition herein.

The fluid which is contemplated for use in one non-limiting aspect of the methods and compositions herein for treatment of a subterranean well for enhancement of production will be aqueous based; that is, it may be formed using sea water available at the well location, a brine, tap water or similar fluid. The amount of fluid used for the treatment will vary, of course, from well to well, and will be based upon the particular application at hand, and the amount thereof is not particularly critical to the method. It will be appreciated that one of ordinary skill in the art of corrosion inhibition will be able to adapt the teachings herein to applications outside the realm of oil and gas recovery, such as the area of chemical processing, with only routine experimentation.

The treatment fluid also contemplates incorporation of other corrosion inhibitors, which typically will be provided in treatment concentrations of from about 1,000 ppm, based upon the weight of the entire treatment fluid to about 60,000 ppm of such weight. Most often, the total amount of corrosion inhibitors will range from about 1,000 independently up to 30,000 ppm. The treatment level of the corrosion inhibitor will again depend upon the particular physical characteristics of the well, the high alloy steel conduit, temperature and pressure considerations, the selected acidic injection medium, and the like.

The invention will be described further in the following illustrative Examples, which are non-limiting and serve only to further illuminate the invention.

To simulate continuous treatment in a high flow rate pipeline, the testing was performed using a rotating cylinder electrode (RCE) in presence of oil and water. To stimulate batch treatment at high temperature, a highly concentrated corrosion inhibitor was added initially and the test fluid was replaced by exchanging fresh fluid twice during the first two hours to test their film persistency. These are well-known testing procedures in the industry. Without wishing to be limited to any particular explanation, it is believed that the corrosion inhibitors herein protect the metals by a film thereon, which is believed to be true for both continuous and for low flow or stagnant environments.

### EXAMPLE 1

The 10% active imidazoline “dimer/oligomers” reaction product was dissolved in water as an amine acetic salt. The rotation cylinder electrode (RCE) test was run at low concentrations under conditions of 6000 rpm and 71° C. and continuously sparging with CO₂. The brine composition was 0.37 g/liter CaCl₂.2H₂O, 2.73 g/l MgCl2.6H₂O, 0.54 g/l Na₂SO₄, 1.83 g/l NaHCO₃, 17.65 g/l NaCl. The oil was Isopar M, a paraffinic solvent available from ExxonMobil. The brine/oil ratio was 80/20. The corrosion rate was monitored by linear polarization resistance (LPR) method. After about 60 minutes of pre-corrosion, the inhibitor was added to the cells at a concentration of 1-10 ppm. LPR monitoring continued for 20 hours. The results were shown below, in mils per year (mpy):

TABLE I
Corrosion Inhibition Results from Example 1

| | Conventional | |
|---|---|---|
| Corrosion Inhibitor | Monomeric Imidazoline | Dimer Imidazoline |
| 0 ppm | 188 mpy | 188 mpy |
| 1 ppm | 185 mpy | 13 mpy |
| 2 ppm | 13 mpy | 5 mpy |
| 5 ppm | 1 mpy | 0.9 mpy |

It can be seen from the results in Table I that the dimer imidazoline of the compositions and methods herein has superior corrosion inhibition properties as compared to that of conventional oleic imidazoline, under the above test conditions.

### EXAMPLE 2

The film persistency of corrosion inhibitor was also tested. Carbon steel coupons were treated by 500 ppm corrosion inhibitors with sparging CO₂. The oil/brine ratio was 20/80. The mild steel coupons were left at 82° C. for 1 hour. After that, a fresh fluid was replaced and placed in pressurized wheel bomb test. The weight loss method was used to measure corrosion rate. 55 ml of CO₂ sparged 10/90 Isopar M/water mixture was filled into the bomb, and charged with 14.7 psi (101.3 kPa) CO₂ at ambient temperature. The pressure vessel was then installed on the wheel test and rotated. The test temperature was 177° C., and the test duration was 24 hours. The surface area of the test coupon was 2.42 in² (15.6 cm²).

The corrosion rate and protection was calculated as following:

Corrosion rate (CR), MPY=ΔW×534/(ρ×A×T) (1)

Percent protection, % P=(CR_{blank}−CR_{inhib})×100/CR_{blank} (2)

Where ΔW is the difference in weight loss before and after corrosion in mg, ρ is the density of the metal coupon in g/cm³ (7.86 g/cm³ for mild steel), A is the coupon area in square inches, T is time of exposure in hours and MPY is mils per year.

The results are shown in Table II below, ratios are volume/volume:

TABLE II
Film Persistency Test Results for Example 2

| Ex. | | Corrosion | |
|---|---|---|---|
| No. | Corrosion Inhibitors | Rate (mpy) | Protection % |
| A | Blank | 34.9 | 0 |
| B | Conventional Imidazoline | 7.2 | 79.3 |
| C | Dimer Imidazoline | 5.2 | 85.1 |
| D | Conventional Monomeric | 5.6 | 83.9 |
| | Imidazoline/Oleic Acid (1/1) | | |
| E | Dimer Imidazoline/Oleic Acid (1/1) | 2.0 | 94.3 |

It may be seen that the dimeric imidazoline has superior corrosion inhibition to that of regular imidazoline in the film persistency test. The mixed corrosion inhibitor with fatty acid (oleic) also gave the same trends. This shows that the protective film formed on a metal surface lasted a longer time with dimeric imidazoline than with conventional monomeric imidazoline.

### EXAMPLE 3

The effect of different molecular weight imidazoline was also studied using the test condition that was the same as Example 1. The relative molecular weight was determined by GPC with polystyrene as the standard.

TABLE III
RCE Test Results with Different Molecular Weight Material

| | | RCE corrosion |
|---|---|---|
| Ratio of dimeric | Weight Average | rate at 1 ppm |
| acid:Diethylenetriamine | Molecular Weight | corrosion inhibitor |
| 1:3 Reaction Product | 608 | 13 mpy |
| 1:1 Reaction Product | 4188 | 186 mpy |
| Blank | N/A | 188 mpy |

From Table III, it may be seen that high molecular weight dimer acid/diethylenetriamine reaction products are not effective corrosion inhibitors. However, the 1:3 reaction product of the present discovery was an effective corrosion inhibitor.

Many modifications may be made in the present invention without departing from the spirit and scope thereof that are defined only by the appended claims. For example, certain components per se, or combinations of components thereof other than those specifically set out herein may be found by one of routine skill in the art to be particularly advantageous, e.g. different combinations of dimer acid and polyamine reactants, different inventive imidazoline corrosion inhibitors with certain solvents and/or different combinations of surfactants or dispersants are expected to fall within the scope of the invention as outlined in the claims. Additionally, certain proportions of reactants may produce corrosion inhibitors having particular efficacy, and certain proportion or dosages of the inventive imidazoline corrosion inhibitors may have optimum effectiveness for particular environments, fluids and/or metals.

The terms “comprising” and “comprises” as used in the claims shall be interpreted as “including but not limited to” the recited elements.

What is claimed is:

1. A method of inhibiting the corrosion of a metal in contact with a liquid comprising water, the method comprising adding to the liquid an imidazoline reaction product of a dimeric fatty acid and a dialkylene triamine, where the molar ratio of dimeric fatty acid to dialkylene triamine ranges from 1:2 to 1:4, and where the amount of the imidazoline reaction product is effective to inhibit corrosion of the metal.

2. The method of claim 1 where the amount of the imidazoline reaction product ranges from about 1 ppm to about 500 ppm, based on the liquid.

3. The method of claim 1 where the dialkylene triamine is diethylene triamine.

4. The method of claim 1 where the imidazoline reaction product has a weight average molecular weight between about 400 and about 1200.

5. The method of claim 1 where the liquid further comprises at least one hydrocarbon and a corrosive component selected from the group consisting of CO₂ and H₂S.

6. A method of inhibiting the corrosion of a metal in contact with a liquid comprising water, at least one hydrocarbon and a corrosive component selected from the group consisting of CO₂ and H₂S, the method comprising adding to the liquid from about 1 ppm to about 500 ppm based on the liquid, of an imidazoline reaction product of a dimeric fatty acid and a dialkylene triamine, where the molar ratio of dimeric fatty acid to dialkylene triamine ranges from 1:2 to 1:4.

7. The method of claim 6 where the dialkylene triamine is diethylene triamine.

8. The method of claim 6 where the imidazoline reaction product has a weight average molecular weight between about 400 and about 1200.

9. A corrosion inhibited liquid in contact with a metal, where the liquid comprises water and an imidazoline reaction product of a dimeric fatty acid and a dialkylene triamine, where the molar ratio of dimeric fatty acid to dialkylene triamine ranges from 1:2 to 1:4, and where the amount of the imidazoline reaction product is effective to inhibit corrosion of the metal.

10. The corrosion inhibited liquid of claim 9 where the amount of the imidazoline reaction product ranges from about 1 ppm to about 500 ppm, based on the liquid.

11. The corrosion inhibited liquid of claim 9 where the dialkylene triamine is diethylene triamine.

12. The corrosion inhibited liquid of claim 9 where the imidazoline reaction product has a weight average molecular weight between about 400 and about 1200.

13. The corrosion inhibited liquid of claim 9 where the liquid further comprises at least one hydrocarbon and a corrosive component selected from the group consisting of CO₂ and H₂S.

14. A corrosion inhibited liquid in contact with a metal, where the liquid comprises water, at least one hydrocarbon and a corrosive component selected from the group consisting of CO₂ and H₂S, and from about 1 ppm to about 500 ppm based on the liquid, of an imidazoline reaction product of a dimeric fatty acid and a dialkylene triamine, where the molar ratio of dimeric fatty acid to dialkylene triamine ranges from 1:2 to 1:4.

15. The corrosion inhibited liquid of claim 14 where the dialkylene triamine is diethylene triamine.

16. The corrosion inhibited liquid of claim 14 where the imidazoline reaction product has a weight average molecular weight between about 400 and about 1200.
